(19) United States
(12) Patent Application Publication
(10) Pub. No.: US 2023/0417943 A1
(43) Pub. Date: Dec. 28, 2023

(54) METHOD OF LOCATING FAILURE IN COAL-ROCK-CONCRETE BASED ON VECTOR FEATURES OF NEAR-FIELD ELECTROMAGNETIC FIELD

(71) Applicant: University of Science and Technology Beijing, Beijing (CN)

(72) Inventors: Dazhao SONG, Beijing (CN); Yuqing CHENG, Beijing (CN); Xueqiu HE, Beijing (CN); Menghan WEI, Beijing (CN); Yongjun TONG, Beijing (CN)

(73) Assignee: University of Science and Technology Beijing, Beijing (CN)

(21) Appl. No.: 17/940,005

(22) Filed: Sep. 8, 2022

(30) Foreign Application Priority Data
Jun. 22, 2022 (CN) 202210710286.7

(51) Int. Cl. G01V 3/08

(52) U.S. Cl. CPC G01V 3/081

(57) ABSTRACT

A method of locating a failure of coal-rock-concrete based on vector features of a near-field electromagnetic field is provided. The method senses and records the real electromagnetic field vector information in space by arranging a triaxial electromagnetic sensor array around a coal-rock-concrete body, and realizes the localization of the failure areas of the coal-rock-concrete body by establishing an electromagnetic radiation localization model for the failures of the coal-rock concrete body. The electromagnetic radiation localization model for the failures of the coal-rock concrete body approximates the radiation source of electromagnetic radiation generated by failures as a dipole with a dipole moment, so as to realize the localization of a large number of relatively small-intensity failures during the disaster incubation stage and evolution process, realize the monitoring and early warning of the final disaster locations, and further improve the reliability of electromagnetic radiation positioning technology.

### CROSS REFERENCE TO THE RELATED APPLICATIONS

This application is based upon and claims priority to Chinese Patent Application No. 202210710286.7, filed on Jun. 22, 2022, the entire contents of which are incorporated herein by reference.

### TECHNICAL FIELD

The present invention relates to the field of prevention and control technology of dynamic disasters in coal-rock-concrete, and specially relates to a method of locating a failure in coal-rock-concrete based on vector features of a near-field electromagnetic field.

### BACKGROUND

With the continuous increase of the quantity and depth of mining mineral resources, mine dynamic disasters occur frequently, and the number of occurrences and the number of deaths has shown an upward trend, which has greatly threatened the safety of mine production. Therefore, the monitoring and early warning of mine dynamic disasters is becoming more and more important. The electromagnetic radiation method proposed based on the physical indicators of the earth is a very promising monitoring method that can effectively monitor the mine dynamic disasters. At present, a certain progress has been made in the fields including the research objects, mechanisms, spectrum characteristics of the electromagnetic radiation, and monitoring and early warning of mine dynamic disasters in recent years.

At present, the electromagnetic radiation monitoring technology of coal-rock-concrete mainly realizes the tracking and early warning of the incubation and development process of coal-rock-concrete dynamic disasters by analyzing the time series changes of parameters such as signal intensity and pulse number, but cannot determine a location of a disaster-pregnant area, so as to provide limited information for disaster prevention and control, which restricts the application of this technology. In addition, the large number of relatively small failures produced by coal-rock-concrete during the disaster incubation stage and evolution process have an important precursory role in locating the final disaster location, but the current monitoring methods are still unable to locate these small damage events.

### SUMMARY

In response to the above problems, the purpose of the present invention is to provide a method of locating a failure in coal-rock-concrete based on vector features of a near-field electromagnetic field. By establishing an electromagnetic radiation localization model for failures of a coal-rock concrete body, the accurate location of the failure area of the coal-rock concrete body can be realized, which is of great significance to the monitoring and early warning of mine dynamic disasters.

In order to solve the above technical problems, the embodiment of the present invention provides the following solutions.

A method of locating a failure in coal-rock-concrete based on vector features of a near-field electromagnetic field is provided. The method includes the following steps:

step A: establishing a unified cartesian coordinate system, arranging a sensor array consisting of N triaxial electromagnetic sensors around a coal-rock-concrete body to ensure that a test axis of each triaxial electromagnetic sensor is parallel to the cartesian coordinate system, and recording coordinates of each triaxial electromagnetic sensor as

r^{(j)}=(x^{(j)},y^{(j)},z^{(j)}),j=1,2, . . . ,N,N≥2;

step B: recording a monitored electromagnetic field signal caused by the failure in the coal-rock-concrete body as E^{(j)}=(Eₓ^{(j)},E_{y}^{(j)},E_{z}^{(j)}), and regarding the electromagnetic field signal as a dipole-radiation near-field electric field E=E(r₀,p₀) generated by a dipole moment p₀=(pₓ,p_{y},p_{z}) at a position r₀=(x₀,y₀,z₀) where the failure occurs. Other parameters are known;

step C: obtaining a nonlinear equation group containing unknown parameters by using any two triaxial electromagnetic sensors with numbers j₁ and j₂ as a group, obtaining a set of solutions formed by (x₀, y₀, z₀) which is determined by the nonlinear equation group, and constructing an envelope surface corresponding to the set of solutions, where an area surrounded by the envelope surface corresponds to a failure area of the coal-rock-concrete body; and

step D: by repeating step B and step C, obtaining C_{N}² sets of solutions based on the N triaxial electromagnetic sensors of the sensor array, obtaining failure areas of the coal-rock-concrete body determined by the C_{N}² groups of the triaxial electromagnetic sensors, performing an intersection operation on all the obtained failure areas of the coal-rock-concrete body, performing statistics on data obtained by the intersection operation, and determining a final failure area of the coal-rock-concrete body.

Preferably, the dipole-radiation near-field electric field in step B is determined by equations of:

$$E = \frac{\vert {p}_{0} \vert}{4 π {ε}_{0} {\vert r \vert}^{3}} ( 2 cos θ \frac{r}{\vert r \vert} + sin θ \frac{{p}_{0} \times r \times r}{\vert {p}_{0} \times r \times r \vert} ) cos ω t \\ r = {r}^{( j )} - {r}_{0} , θ = arc cos \frac{r \cdot {p}_{0}}{\vert r \vert \vert {p}_{0} \vert} ∘$$

Preferably, in the nonlinear equation group in step C, the left side of the equation group is the dipole-radiation near-field electric field at locations of the two triaxial electromagnetic sensors with unknown parameters (x₀, y₀, z₀, pₓ, p_{y}, p_{z}), the right side of the equation group are six electric field intensity components measured by the two triaxial electromagnetic sensors, and the nonlinear equation group has the following form:

$$\{ \begin{matrix}\vert {E}_{x} ( {x}_{0} , {y}_{0} , {z}_{0} , {p}_{x} , {p}_{y} , {p}_{z} ; {x}^{( {j}_{1} )} , {y}^{( {j}_{1} )} , {z}^{( {j}_{1} )} ) \vert = \vert {E}_{x}^{( {j}_{1} )} \vert \\ \vert {E}_{x} ( {x}_{0} , {y}_{0} , {z}_{0} , {p}_{x} , {p}_{y} , {p}_{z} ; {x}^{( {j}_{2} )} , {y}^{( {j}_{2} )} , {z}^{( {j}_{2} )} ) \vert = \vert {E}_{x}^{( {j}_{2} )} \vert \\ \vert {E}_{y} ( {x}_{0} , {y}_{0} , {z}_{0} , {p}_{x} , {p}_{y} , {p}_{z} ; {x}^{( {j}_{1} )} , {y}^{( {j}_{1} )} , {z}^{( {j}_{1} )} ) \vert = \vert {E}_{y}^{( {j}_{1} )} \vert \\ \vert {E}_{y} ( {x}_{0} , {y}_{0} , {z}_{0} , {p}_{x} , {p}_{y} , {p}_{z} ; {x}^{( {j}_{2} )} , {y}^{( {j}_{2} )} , {z}^{( {j}_{2} )} ) \vert = \vert {E}_{y}^{( {j}_{2} )} \vert \\ \vert {E}_{z} ( {x}_{0} , {y}_{0} , {z}_{0} , {p}_{x} , {p}_{y} , {p}_{z} ; {x}^{( {j}_{1} )} , {y}^{( {j}_{1} )} , {z}^{( {j}_{1} )} ) \vert = \vert {E}_{z}^{( {j}_{1} )} \vert \\ \vert {E}_{z} ( {x}_{0} , {y}_{0} , {z}_{0} , {p}_{x} , {p}_{y} , {p}_{z} ; {x}^{( {j}_{1} )} , {y}^{( {j}_{1} )} , {z}^{( {j}_{1} )} ) \vert = \vert {E}_{z}^{( {j}_{1} )} \vert\end{matrix} .$$

Preferably, in a process of performing the intersection operation and performing statistics on the data obtained by the intersection operation in step D, if an intersection area is obtained directly, invalid data that is not in the intersection area is deleted, valid data in the intersection area is kept, coordinates (x₀, y₀, z₀) of the failure areas of the coal-rock-concrete and a corresponding error (Δx₀, Δy₀, Δz₀) are obtained after statistics of the valid data, and the above coordinate range is the final failure area of coal-rock-concrete body.

Preferably, in a process of performing the intersection operation and performing statistics on the data obtained by the intersection operation in step D, if the intersection operation returns an empty set, the measured C_{N}² failure areas of the coal-rock-concrete body are projected into the three coordinate axis planes, respectively, intersection areas are determined in the three coordinate axis planes, respectively, and two sets of effective statistical data [(x₁, x₂), (y₁, y₂), (z₁, z₂)] and corresponding statistical errors [(Δx₁, Δx₂), (Δy₁, Δy₂), (Δz₁, Δz₂)] are obtained after statistics of all the solutions in the three intersection areas, a positioning result (xₘ, yₘ, zₘ) with the smallest statistical error and the corresponding smallest statistical error (Δxₘ, Δyₘ, Δzₘ) are determined, and the above coordinate range is the final failure area of the coal-rock-concrete body.

The technical solutions provided in the embodiments of the present invention at least brings the following advantages.

A method for locating a failure of coal-rock-concrete based on vector features of a near-field electromagnetic field provided by the present invention senses and records the real electromagnetic field vector information in space by arranging a triaxial electromagnetic sensor array around a coal-rock-concrete body, and realizes the localization of the failure areas of the coal-rock-concrete body by establishing an electromagnetic radiation localization model for the failures of the coal-rock concrete body. The electromagnetic radiation localization model for the failures of the coal-rock concrete body approximates the radiation source of electromagnetic radiation generated by failures as a dipole with a dipole moment, so as to realize the localization of a large number of relatively small-intensity failures during the disaster incubation stage and evolution process, realize the monitoring and early warning of the final disaster locations, and further improve the reliability of electromagnetic radiation positioning technology.

### BRIEF DESCRIPTION OF THE DRAWINGS

In order to explain the technical solution in the embodiments of the present invention more clearly, the drawings used in the embodiments are briefly described below. Obviously, the drawings in the following description are only some of the embodiments of the present invention. For those skilled in the art, other drawings may also be obtained from these drawings without any creative effort

FIG. 1 is a flowchart illustrating a method of locating failures of coal-rock-concrete based on vector features of a near-field electromagnetic field provided by embodiments of the present invention;

FIG. 2 is a schematic diagram illustrating the principle of locating failure areas of a coal-rock-concrete body based on an electric dipole moment provided by embodiments of the present invention; and

FIG. 3A and FIG. 3B are diagrams illustrating the effect of locating failures of coal-rock-concrete based on vector features of a near-field electromagnetic field provided by embodiments of the present invention, respectively.

### DETAILED DESCRIPTION OF THE EMBODIMENTS

The technical solutions in the embodiments of the present invention are clearly and completely described below with reference to the accompanying drawings in the embodiments of the present invention. Obviously, the described embodiments are only part, not all of the embodiments of the present invention. Based on the embodiments of the present invention, all other embodiments obtained by those skilled in the art without creative efforts shall fall within the protection scope of the present invention.

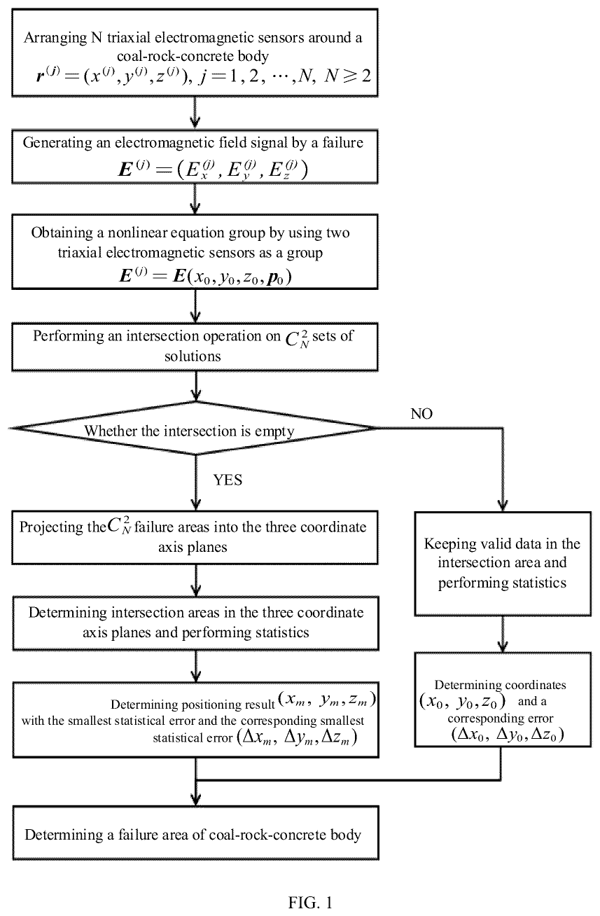

The embodiments of the present invention provide a method of locating a failure of coal-rock-concrete based on vector features of a near-field electromagnetic field. As shown in FIG. 1, the method includes the following steps:

Step A: establishing a unified cartesian coordinate system, arranging a sensor array consisting of N triaxial electromagnetic sensors around a coal-rock-concrete body to ensure that a test axis of each triaxial electromagnetic sensor is parallel to the cartesian coordinate system, and recording coordinates of each triaxial electromagnetic sensor as

r^{(j)}=(x^{(j)},y^{(j)},z^{(j)}),j=1,2, . . . ,N,N≥2.

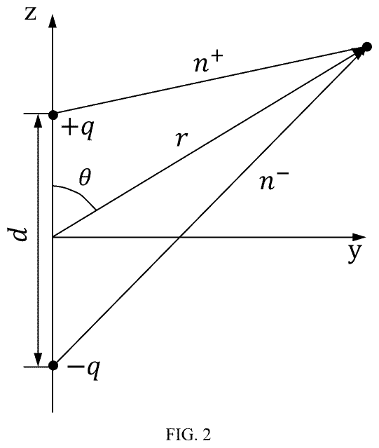

Step B: recording a monitored electromagnetic field signal caused by the failure in the coal-rock-concrete body as E^{(j)}=(Eₓ^{(j)}, E_{y}^{(j)},E_{z}^{(j)}), and regarding the electromagnetic field signal as a dipole-radiation near-field electric field E=E(r₀,p₀) generated by a dipole moment p₀=(pₓ,p_{y},p_{z}) at a position r₀=(x₀,y₀,z₀) where the failure occurs. Other parameters are known. The principle of electric dipole moment positioning is shown in FIG. 2.

The dipole-radiation near-field electric field in step B is determined by equations of:

$$E = \frac{\vert {p}_{0} \vert}{4 π {ε}_{0} {\vert r \vert}^{3}} ( 2 cos θ \frac{r}{\vert r \vert} + sin θ \frac{{p}_{0} \times r \times r}{\vert {p}_{0} \times r \times r \vert} ) cos ω t \\ r = {r}^{( j )} - {r}_{0} , θ = arc cos \frac{r \cdot {p}_{0}}{\vert r \vert \vert {p}_{0} \vert} .$$

Step C: obtaining a nonlinear equation group containing unknown parameters by using any two triaxial electromagnetic sensors with numbers j₁ and j₂ as a group, obtaining a set of solutions formed by (x₀, y₀, z₀) which is determined by the nonlinear equation group, and constructing an envelope surface corresponding to the set of solutions, where an area surrounded by the envelope surface corresponds to a failure area of the coal-rock-concrete body.

In the nonlinear equation group in step C, the left side of the equation group is the dipole-radiation near-field electric field at locations of the two triaxial electromagnetic sensors with unknown parameters (x₀, y₀, z₀, pₓ, p_{y}, p_{z}), the right side of the equation group are six electric field intensity components measured by the two triaxial electromagnetic sensors, and the nonlinear equation group has the following form:

$$\{ \begin{matrix}\vert {E}_{x} ( {x}_{0} , {y}_{0} , {z}_{0} , {p}_{x} , {p}_{y} , {p}_{z} ; {x}^{( {j}_{1} )} , {y}^{( {j}_{1} )} , {z}^{( {j}_{1} )} ) \vert = \vert {E}_{x}^{( {j}_{1} )} \vert \\ \vert {E}_{x} ( {x}_{0} , {y}_{0} , {z}_{0} , {p}_{x} , {p}_{y} , {p}_{z} ; {x}^{( {j}_{2} )} , {y}^{( {j}_{2} )} , {z}^{( {j}_{2} )} ) \vert = \vert {E}_{x}^{( {j}_{2} )} \vert \\ \vert {E}_{y} ( {x}_{0} , {y}_{0} , {z}_{0} , {p}_{x} , {p}_{y} , {p}_{z} ; {x}^{( {j}_{1} )} , {y}^{( {j}_{1} )} , {z}^{( {j}_{1} )} ) \vert = \vert {E}_{y}^{( {j}_{1} )} \vert \\ \vert {E}_{y} ( {x}_{0} , {y}_{0} , {z}_{0} , {p}_{x} , {p}_{y} , {p}_{z} ; {x}^{( {j}_{2} )} , {y}^{( {j}_{2} )} , {z}^{( {j}_{2} )} ) \vert = \vert {E}_{y}^{( {j}_{2} )} \vert \\ \vert {E}_{z} ( {x}_{0} , {y}_{0} , {z}_{0} , {p}_{x} , {p}_{y} , {p}_{z} ; {x}^{( {j}_{1} )} , {y}^{( {j}_{1} )} , {z}^{( {j}_{1} )} ) \vert = \vert {E}_{z}^{( {j}_{1} )} \vert \\ \vert {E}_{z} ( {x}_{0} , {y}_{0} , {z}_{0} , {p}_{x} , {p}_{y} , {p}_{z} ; {x}^{( {j}_{1} )} , {y}^{( {j}_{1} )} , {z}^{( {j}_{1} )} ) \vert = \vert {E}_{z}^{( {j}_{1} )} \vert\end{matrix} .$$

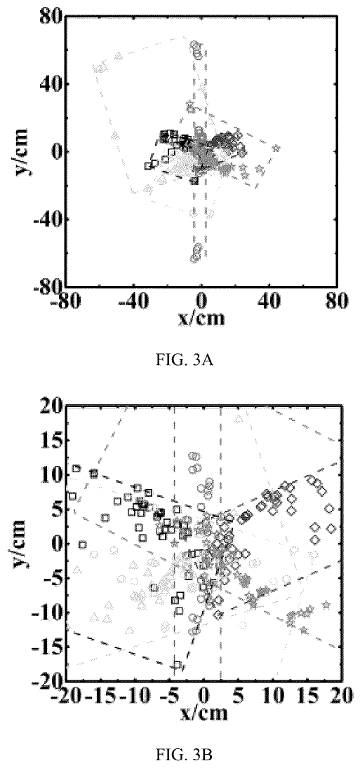

Step D: by repeating step B and step C, obtaining C_{N}² sets of solutions based on the N triaxial electromagnetic sensors of the sensor array, obtaining failure areas of the coal-rock-concrete body determined by the C_{N}² groups of the triaxial electromagnetic sensors, performing an intersection operation on all the obtained failure areas of the coal-rock-concrete body, performing statistics on the data obtained by the intersection operation, and determining a final failure area of the coal-rock-concrete body. The solution results are shown in FIG. 3A and FIG. 3B.

In a process of performing the intersection operation and performing statistics on the data obtained by the intersection operation in step D, if an intersection area is obtained directly, invalid data that is not in the intersection area is deleted, valid data in the intersection area is kept, coordinates (x₀, y₀,z₀) of the failure areas of the coal-rock-concrete and a corresponding error (Δx₀, Δy₀,Δz₀) are obtained after statistics of the valid data, and the above coordinate range is the final failure area of coal-rock-concrete body.

In a process of performing the intersection operation and performing statistics on the data obtained by the intersection operation in step D, if the intersection operation returns an empty set, the measured C_{N}² failure areas of the coal-rock-concrete body are projected into the three coordinate axis planes, respectively, intersection areas are determined in the three coordinate axis planes, respectively, and two sets of effective statistical data [(x₁, x₂), (y₁, y₂), (z₁, z₂)] and corresponding statistical errors [(Δx₁, Δx₂), (Δy₁, Δy₂), (Δz₁, Δz₂)] are obtained after statistics of all the solutions in the three intersection areas, a positioning result (xₘ, yₘ, zₘ) with the smallest statistical error and the corresponding smallest statistical error (Δxₘ, Δyₘ, Δzₘ) are determined, and the above coordinate range is the final failure area of the coal-rock-concrete body.

In summary, a method for locating a failure of coal-rock-concrete based on vector features of a near-field electromagnetic field provided by the present invention senses and records the real electromagnetic field vector information in space by arranging a triaxial electromagnetic sensor array around a coal-rock-concrete body, and realizes the localization of the failure areas of the coal-rock-concrete body by establishing an electromagnetic radiation localization model for the failures of the coal-rock concrete body. The electromagnetic radiation localization model for the failures of the coal-rock concrete body approximates the radiation source of electromagnetic radiation generated by failures as a dipole with a dipole moment, so as to realize the localization of a large number of relatively small-intensity failures during the disaster incubation stage and evolution process, realize the monitoring and early warning of the final disaster locations, and further improve the reliability of electromagnetic radiation positioning technology.

It should be noted that the “one embodiment”, “embodiments”, “exemplary embodiments”, “exemplary embodiment”, and “some embodiments” indicate that they may include specific features or characteristics, but not every embodiment includes the specific features or characteristics. Additionally, when the specific features or characteristics are described in connection with one embodiment, it is within the knowledge of those skilled in the art to implement such features or characteristics in connection with other embodiments, whether explicitly described or not.

Usually, the terms can be understood at least from the context. For example, at least part depends on the context. The term “one or more” used in this invention can be used to describe any features, structures or characteristics in the singular form, or a combination of features, structures or characteristics in plural forms. In addition, the term “based on” may be understood as not necessarily intended to convey an exclusive set of factors, but may instead, depending at least in part on the context, allow for the presence of other factors that are not necessarily explicitly described.

The present invention covers any alternative, modification, equivalent methods and solutions made within the spirit and scope of the present invention. In order to give the public a thorough understanding of the present invention, specific details are described in detail in the following preferred embodiments of the present invention, and those skilled in the art can fully understand the present invention without the description of these details. In addition, in order to avoid unnecessary confusion about the essence of the present invention, well-known methods, processes, procedures, components, circuits, etc., have not been described in detail.

Those of ordinary skill in the art can understand that all or part of the steps in the methods of the above embodiments can be completed by instructing relevant hardware through a program, and the program can be stored in a computer-readable storage medium, such as: ROM/RAM, disk, CD, etc.

The above descriptions are only preferred embodiments of the present invention, and are not intended to limit the present invention. Any modification, equivalent replacement, improvement, etc. made within the spirit and principle of the present invention shall be included within the protection scope of the present invention.

What is claimed is:

1. A method of locating a failure in coal-rock-concrete based on vector features of a near-field electromagnetic field, comprising the following steps:
step A: establishing a unified cartesian coordinate system, arranging a sensor array around a coal-rock-concrete body, wherein the sensor array comprises N triaxial electromagnetic sensors, to ensure that a test axis of each of the N triaxial electromagnetic sensors is parallel to the cartesian coordinate system, and recording coordinates of each of the N triaxial electromagnetic sensors as r^{(j)}=(x^{(j)},y^{(j)},z^{(j)}), j=1, 2, . . . , N, N≥2;
step B: recording a monitored electromagnetic field signal as E^{(j)}=(Eₓ^{(j)},E_{y}^{(j)},E_{z}^{(j)}), wherein the monitored electromagnetic field signal is caused by the failure in the coal-rock-concrete body, and regarding the electromagnetic field signal as a dipole-radiation near-field electric field E=E(r₀,p₀), wherein the dipole-radiation near-field electric field is generated by a dipole moment p₀=(pₓ,p_{y},p_{z}), the dipole moment is at a position r₀=(x₀,y₀,z₀), the failure occurs at the position, wherein other parameters are known;
step C: obtaining a nonlinear equation group, wherein the nonlinear equation group contains unknown parameters (x₀, y₀,z₀,pₓ,p_{y},p_{z}) by using any two triaxial electromagnetic sensors of the N triaxial electromagnetic sensors as a group, wherein the two triaxial electromagnetic sensors is with numbers j₁ and j₂, respectively, obtaining a set of solutions, wherein the set of solutions is formed by (x₀, y₀, z₀), the set of solutions is determined by the nonlinear equation group, and constructing an envelope surface corresponding to the set of solutions, wherein an area corresponds to a failure area of the coal-rock-concrete body, wherein the area is surrounded by the envelope surface; and
step D: by repeating step B and step C, obtaining C_{N}² sets of solutions based on the N triaxial electromagnetic sensors of the sensor array, obtaining failure areas of the coal-rock-concrete body, wherein the failure areas of the coal-rock-concrete body is determined by the C_{N}² groups of triaxial electromagnetic sensors of the N triaxial electromagnetic sensors, performing an intersection operation on the failure areas of the coal-rock-concrete body, performing statistics on data obtained by the intersection operation, and determining a final failure area of the coal-rock-concrete body.

2. The method according to claim 1, wherein the dipole-radiation near-field electric field in step B is determined by equations of:
$$E = \frac{\vert P \vert}{4 π {ε}_{0} {\vert r \vert}^{3}} ( 2 cos θ \frac{r}{\vert r \vert} + sin θ \frac{{p}_{0} \times r \times r}{\vert {p}_{0} \times r \times r \vert} ) cos ω t$$
$$r = {r}^{( j )} - {r}_{0} , θ = arccos \frac{r \cdot {p}_{0}}{\vert r \vert \vert {p}_{0} \vert}$$

3. The method according to claim 1, wherein in the nonlinear equation group in step C, a left side of the nonlinear equation group is the dipole-radiation near-field electric field, wherein the dipole-radiation near-field electric field is at locations of the two triaxial electromagnetic sensors, the dipole-radiation near-field electric field is with the unknown parameters (x₀, y₀, z₀, pₓ, p_{y}, p_{z}), a right side of the nonlinear equation group are six electric field intensity components, wherein the six electric field intensity components are measured by the two triaxial electromagnetic sensors, and the nonlinear equation group has the following form:
$$\{ \begin{matrix}\vert {E}_{x} ( {x}_{0} , {y}_{0} , {z}_{0} , {p}_{x} , {p}_{y} , {p}_{z} ; {x}^{( {j}_{1} )} , {y}^{( {j}_{1} )} , {z}^{( {j}_{1} )} ) \vert = \vert {E}_{x}^{( {j}_{1} )} \vert \\ \vert {E}_{x} ( {x}_{0} , {y}_{0} , {z}_{0} , {p}_{x} , {p}_{y} , {p}_{z} ; {x}^{( {j}_{2} )} , {y}^{( {j}_{2} )} , {z}^{( {j}_{2} )} ) \vert = \vert {E}_{x}^{( {j}_{2} )} \vert \\ \vert {E}_{y} ( {x}_{0} , {y}_{0} , {z}_{0} , {p}_{x} , {p}_{y} , {p}_{z} ; {x}^{( {j}_{1} )} , {y}^{( {j}_{1} )} , {z}^{( {j}_{1} )} ) \vert = \vert {E}_{y}^{( {j}_{1} )} \vert \\ \vert {E}_{y} ( {x}_{0} , {y}_{0} , {z}_{0} , {p}_{x} , {p}_{y} , {p}_{z} ; {x}^{( {j}_{2} )} , {y}^{( {j}_{2} )} , {z}^{( {j}_{2} )} ) \vert = \vert {E}_{y}^{( {j}_{2} )} \vert \\ \vert {E}_{z} ( {x}_{0} , {y}_{0} , {z}_{0} , {p}_{x} , {p}_{y} , {p}_{z} ; {x}^{( {j}_{1} )} , {y}^{( {j}_{1} )} , {z}^{( {j}_{1} )} ) \vert = \vert {E}_{z}^{( {j}_{1} )} \vert \\ \vert {E}_{z} ( {x}_{0} , {y}_{0} , {z}_{0} , {p}_{x} , {p}_{y} , {p}_{z} ; {x}^{( {j}_{1} )} , {y}^{( {j}_{1} )} , {z}^{( {j}_{1} )} ) \vert = \vert {E}_{z}^{( {j}_{1} )} \vert\end{matrix} .$$

4. The method according to claim 1, wherein in a process of performing the intersection operation and performing the statistics on the data obtained by the intersection operation in step D, if an intersection area is obtained directly, invalid data is deleted, wherein the invalid data is not in the intersection area, valid data in the intersection area is kept, coordinates (x₀, y₀, z₀) of the failure areas of the coal-rock-concrete body and a error (Δx₀, Δy₀, Δz₀) corresponding to the coordinates (x₀, y₀, z₀) are obtained after statistics of the valid data, and a coordinate range is the final failure area of coal-rock-concrete body, wherein the coordinate range consists of (x₀, y₀, z₀) and (Δx₀, Δy₀, Δz₀).

5. The method according to claim 1, wherein in a process of performing the intersection operation and performing the statistics on the data obtained by the intersection operation in step D, if the intersection operation returns an empty set, the C_{N}² failure areas of the coal-rock-concrete body are projected into three coordinate axis planes, respectively, intersection areas are determined in the three coordinate axis planes, respectively, and two sets of effective statistical data [(x₁, x₂), (y₁, y₂), (z₁, z₂)] and statistical errors [(Δx₁, Δx₂), (Δy₁, Δy₂), (Δz₁, Δz₂)] corresponding to the two sets of effective statistical data [(x₁, x₂), (y₁, y₂), (z₁, z₂)] are obtained after statistics of the solutions in the three intersection areas, a positioning result (xₘ, yₘ, zₘ) and a smallest statistical error (Δxₘ, Δyₘ, Δzₘ) corresponding to the positioning result (xₘ, yₘ, zₘ) are determined, wherein the positioning result (xₘ, yₘ, zₘ) is with the smallest statistical error, and a coordinate range is the final failure area of the coal-rock-concrete body, wherein the coordinate range consists of (xₘ, yₘ, zₘ) and (Δxₘ, Δyₘ, Δzₘ).
